(19) United States
(12) Patent Application Publication
(10) Pub. No.: US 2007/0209288 A1
(43) Pub. Date: Sep. 13, 2007

(54) Semiconductor Polishing Composition

(76) Inventors: Yoshiharu Ohta, Nara (JP); Yasuyuki Itai, Nara (JP)

Correspondence Address: HARNESS, DICKEY & PIERCE, P.L.C., P.O. BOX 8910, RESTON, VA, 20195, US

(21) Appl. No.: 10/594,636

(22) PCT Filed: Mar. 28, 2005
(86) PCT No.: PCT/JP05/05767

§ 371 Date: Sep. 28, 2006

(51) Int. Cl. B24D 3/02; C01B 33/12

(52) U.S. Cl. 51/308; 423/335

(57) ABSTRACT

A semiconductor polishing composition is disclosed. The composition includes fumed silica, the semiconductor polishing composition being an aqueous dispersion solution of fumed silica. A content of the fumed silica includes a particle diameter of 100 nm or less is 15% by volume or more based on a total amount of the fumed silica.

### PRIORITY STATEMENT

This application is the national phase under 35 U.S.C. § 371 of PCT International Application No. PCT/JP2005/005767 which has an International filing date of Mar. 28, 2005, which designated the United States of America and which claims priority on Japanese Patent Application number JP2004-096848 filed Mar. 29, 2004, the entire contents of which are hereby incorporated herein by reference.

### TECHNICAL FIELD

The present invention generally relates to a semiconductor polishing composition.

### BACKGROUND ART

At present, a chemical mechanical polishing (CMP) is an indispensable technology for flattening a semiconductor wafer to achieve high performance and high integration of a semiconductor device.

In the CMP process, a wafer is placed on a pad stuck to a polishing bed so that a surface being polished of a wafer may come into contact with the pad, and, with a pressure head pressed against the wafer to apply a constant weight thereon and with a polishing composition supplying on a pad surface, the pad and the pressure head are rotated to polish the wafer.

The polishing composition is an aqueous slurry in which a polishing agent is dispersed, and, depending on a material of a film formed on a surface being polished of the wafer, an appropriate one is selected from various polishing agents. Among them, a polishing agent made of silica such as colloidal silica and fumed silica is generally used (Japanese Unexamined Patent Publication JP-A 52-47369).

Among the silica base polishing agents, the colloidal silica is excellent in the dispersion stability in water. Accordingly, a polishing composition that is an aqueous dispersion solution of colloidal silica, as far as a concentration of the colloidal silica is in an appropriate range, even after a long storage, is difficult to cause agglomeration of the colloidal silica. However, since the colloidal silica is relatively slow in the polishing speed, there is a problem in that it takes a long time to polish a wafer.

Accordingly, in combination with the colloidal silica, a polishing accelerator such as an organic acid, an oxidizing agent such as hydrogen peroxide, an corrosion inhibitor such as a benzotriazole compound and a surfactant are used.

Furthermore, since the colloidal silica is industrially produced from sodium silicate as a raw material and resultantly contains sodium as an impurity, a wafer is likely to be contaminated at the time of polishing. Accordingly, it becomes necessary to refine colloidal silica to make higher in the purity. Thus, since when the colloidal silica is industrially produced, a refining process to make higher in the purity becomes necessary, the productivity is deteriorated and the producing cost goes up.

On the other hand, fumed silica is faster in the polishing speed than the colloidal silica. In addition, since the fumed silica is synthesized by burning silicon tetrachloride in an oxygen hydrogen flame, the impurity is less contained and the cost is industrially less expensive. However, the fumed silica is insufficient in the aqueous dispersibility.

Accordingly, in a polishing composition that is an aqueous dispersion solution of fumed silica, owing to external loads such as piping load (collision with an inner wall of piping) when supplying to the CMP process, load (pressure owing to a feed pump) of a feed pump, load (pressure load owing to a pressure head) of the pressure head or an environmental condition when conveying, the fumed silica is agglomerated. Furthermore, during the long-term storage, the fumed silica tends to be agglomerated. The fumed silica enlarged by the agglomeration causes a lot of polishing flaws on the wafer.

Such polishing flaws disturb the reliability of the electrical connection of the wafer. When the polishing flaw that is 0.2 μm or more in diameter is caused more than 100 on one wafer, the wafer becomes a defective product to deteriorate the yield of the polishing step.

In view of high polishing speed of the fumed silica and an advantage in the cost thereof, various technologies have been proposed to improve the aqueous dispersibility of the fumed silica.

For instance, there is a method where water and fumed silica are mixed under application of a high shearing force to obtain an aqueous dispersion solution containing the fumed silica at a high concentration, water is added to the aqueous dispersion solution to dilute, and thereby a polishing composition containing a desired concentration of fumed silica is obtained (refer to, for instance, Japanese Examined Patent Publication JP-B2 2935125).

Furthermore, there is a method where, under application of a high shearing force, acid and fumed silica are sequentially added to water and mixed, water is further added thereto, and an alkali aqueous solution is added thereto to obtain a polishing composition containing fumed silica (refer to, for instance, Japanese Examined Patent Publication JP-B2 2949633).

Still furthermore, there is a method where, to water of pH 2 to 4, under application of a high shearing force, fumed silica is added so that a concentration may be 40 to 60% by weight, water is further added to adjust the viscosity to 2 to 10000 cps, followed by stirring for 5 min or more under application of a low shearing force, further followed by adding water to adjust a concentration of fumed silica to 10 to 38% by weight, still further followed by adding alkali under strong stirring to adjust the pH to 9 to 12, and thereby a polishing composition containing fumed silica is obtained (refer to, for instance, Japanese Unexamined Patent Publication JP-A 2001-26771).

However, the polishing compositions described in JP-B2 2935125, JP-B2 2949633 and JP-A 2001-26771, though improved in the aqueous dispersibility of fumed silica in comparison with existing one, are not yet in a sufficiently satisfying level. Accordingly, under the external load and/or during long storage, the fumed silica is unavoidably agglomerated.

### SUMMARY

An object of an embodiment of the invention is to provide a semiconductor polishing composition that is an aqueous dispersion solution of fumed silica and can efficiently polish a semiconductor device such as a wafer at a high polishing speed without causing a polishing flaw.

An embodiment of the invention provides a semiconductor polishing composition comprising:

fumed silica, the semiconductor polishing composition being an aqueous dispersion solution of fumed silica,

wherein a content of the fumed silica having a particle diameter of 100 nm or less is 15% by volume or more based on a total amount of the fumed silica.

Furthermore, in the semiconductor polishing composition according to an embodiment of the invention, it is preferable that a content of fumed silica having a particle diameter of 100 nm or less is in a range of 15 to 90% by volume (15% by volume or more and 90% by volume or less) based on a total amount of the fumed silica.

Still furthermore, in the semiconductor polishing composition according to an embodiment of the invention, it is preferable that in a particle size distribution by volume of the fumed silica, the semiconductor polishing composition has a particle size of the maximum frequency in a range of 115 nm or less.

Furthermore, in the semiconductor polishing composition according to an embodiment of the invention, it is preferable that in a particle size distribution by volume of the fumed silica, the semiconductor polishing composition has a particle size of the maximum frequency in a range of 80 to 115 nm (80 nm or more and 115 nm or less).

Furthermore, in the semiconductor polishing composition according to an embodiment of the invention, it is preferable that a content of the fumed silica is in a range of 10 to 30% by weight (10% by weight or more and 30% by weight or less) based on a total amount of the composition.

Furthermore, in the semiconductor polishing composition according to an embodiment of the invention, it is preferable that the semiconductor polishing composition is prepared by adding an acidic fumed silica dispersion solution to an alkali aqueous solution.

Still furthermore, in the semiconductor polishing composition according to an embodiment of the invention, it is preferable that a pH of the alkali aqueous solution is in a range of 12 to 14 (12 or more and 14 or less).

### BRIEF DESCRIPTION OF DRAWINGS

Other and further objects, features, and advantages of the invention will be more explicit from the following detailed description of example embodiments taken with reference to the drawings wherein:

FIG. 1 is a diagram schematically showing a CMP process;

FIG. 2 is a graph showing, in a semiconductor polishing composition, a volume ratio (%) of particles having and less than each of particle sizes in a total of particles of the fumed silica;

FIG. 3 includes graphs each of which shows, in a semiconductor polishing composition according to an embodiment of the invention, a volume ratio of particles having each of particle diameters in a total amount of particles of the fumed silica as a frequency (%); and

FIG. 4 includes graphs each of which shows, in a semiconductor polishing composition according to Comparative Examples, a volume ratio of particles having each of particle diameters in a total amount of particles of the fumed silica as a frequency (%).

### DETAILED DESCRIPTION OF THE EXAMPLE EMBODIMENTS

Now referring to the drawings, example embodiments of the invention are described below.

A semiconductor polishing composition according to an embodiment of the invention (hereinafter, unless clearly stated, simply referred to as “polishing composition”) is an aqueous dispersion solution of fumed silica in which a content of the fumed silica having a particle diameter of 100 nm or less is 15% by volume or more, preferably in the range of 15 to 90% by volume in a total amount of the fumed silica.

When a content of the fumed silica having a particle diameter of 100 nm or less exceeds 15% by volume, the aqueous dispersibility of the fumed silica is deteriorated. Accordingly, owing to the external load and/or storage, in particular, long-term storage, the fumed silica is agglomerated to generate many polishing flaws on a surface of a semiconductor device such as a wafer.

The polishing composition according to an embodiment of the invention, in a particle size distribution based on the volume of the fumed silica, has a particle diameter of the maximum frequency (that is, a particle diameter largest in the volume ratio in a total amount of the fumed silica) preferably at 115 nm or less, more preferably in the range of 80 to 115 nm. When the maximum frequency is within the above range, an advantage of an embodiment of the invention can be further conspicuously exerted.

In the specification, a volume-base particle size distribution and a volume-base particle size distribution and particle diameter (including an average particle diameter) of the fumed silica are values measured with a laser diffraction/scattering particle size distribution analyzer (trade name: LA910, manufactured by Horiba Ltd.).

As the fumed silica that is used in an embodiment of the invention, one that has been usually used in the field can be used. However, in view of the aqueous dispersibility and the polishing speed, an average primary particle diameter, is preferably in the range of 1 to 500 nm, more preferably in the range of 5 to 300 nm, particularly preferably in the range of 5 to 80 nm.

Furthermore, a specific surface area of the fumed silica is neither restricted particularly, however, when the aqueous dispersibility and the polishing speed thereof are taken into consideration as well, a specific surface area measured by the BET method is preferably 400 m²/g or less, more preferably in the range of 50 to 200 m²/g, particularly preferably in the range of 50 to 150 m²/g.

As the fumed silica, two kinds or more of fumed silica different in the average primary particle diameter and/or the specific surface area can be used together.

The fumed silica can be produced through a vapor-phase hydrolysis of silicon tetrachloride in an oxygen hydrogen flame. Furthermore, a method described in JP-A 2000-86227 can be used to produce. According to the publication, a volatile silicon compound is fed together with a mixed gas containing an inflammable gas and oxygen to a burner and combusted at a temperature in the range of 1000 to 2100° C., and, through the pyrolysis of the volatile silicon compound, fumed silica can be produced. Now, examples of the volatile silicon compound include known compounds such as SiH₄, SiCl₄, CH₃SiCl₃, CH₃SiHCl₂, HSiCl₃, (CH₃)₂SiCl₂, (CH₃)₃SiCl, (CH₃)₂SiH₂, (CH₃)₃SiH and alkoxysilanes. Among these, volatile silicon compounds containing a halogen atom are preferable. The volatile silicon compounds can be used singularly or in a combination of two or more thereof.

As the inflammable gas, one that forms water owing to the combustion in the presence of oxygen is preferable. For instance, hydrogen, methane and butane can be cited. In place of oxygen, air can be used. A mixing ratio of the volatile silicon compound and the mixed gas is appropriately selected depending on the kind of the inflammable gas contained in the mixed gas. For instance, when the inflammable gas is hydrogen, to one mol of the volatile silicon compound, about 2.5 to 3.5 mol of oxygen and about 1.5 to 3.5 mol of hydrogen may be used.

In an embodiment of the invention, commercially available fumed silica can be used as well. Specific examples thereof include AEROSIL 90G and AEROSIL 130 (trade name, manufactured by Nippon Aerosil Co., Ltd.).

A content of the fumed silica in the polishing composition of an embodiment of the invention, without restricting to particular one, can be appropriately selected from a wide range depending on an average primary particle diameter and a specific surface area thereof. However, in view of maintaining the aqueous dispersibility at a high level over a long term and obtaining a high polishing speed, the content of the fumed silica is preferably in the range of 10 to 30% by weight, more preferably in the range of 10 to 28% by weight based on a total amount of the polishing composition.

The polishing composition according to an embodiment of the invention can contain, within a range that does not disturb the aqueous dispersibility of the fumed silica, general additives such as a polishing accelerator, an oxidant, an organic acid, a complexing agent, a corrosion inhibitor and a surfactant.

As the polishing accelerator, for instance, piperazines, primary amine compounds having 1 to 6 carbon atoms and quaternary ammonium salts can be cited. Examples of the piperazines include piperazine, anhydrous piperazine, piperazine hexahydrate, N-aminoethyl piperazine and 1,4-bis (3-aminopropyl)piperazine. Examples of the primary amine compound having 1 to 6 carbon atoms include α-oxyethyl amine (α-aminoethyl alcohol), monoethanol amine (β-aminoethyl alcohol), aminoethylethanolamine, triethylenetetramine and ethylene diamine. Examples of the quaternary ammonium salt include tetramethylammonium chloride, tetramethylammonium hydroxide, dimethyldiethylammonium chloride, N,N-dimethyl morpholinium sulfate and tetrabutylammonium bromide.

The polishing accelerators can be used singularly or in a combination of two or more thereof. A content of the polishing accelerator in the polishing composition of an embodiment of the invention, without particular restriction, is preferably in the range of about 0.001 to 5% by weight based on a total amount of the polishing composition.

Examples of the oxidant include potassium iodate, periodic acid, potassium iodide and iodic acid. The oxidants can be used singularly or in a combination of two or more thereof. A content of the oxidant in the polishing composition of an embodiment of the invention, without particular restriction, is preferably in the range of about 0.01 to 20% by weight based on a total amount of the polishing composition.

Examples of the organic acid include monocarboxylic acids having 2 to 6 carbon atoms such as formic acid, acetic acid, propionic acid, butyric acid, valeric acid and lactic acid; dicarboxylic acids having 2 to 6 carbon atoms such as oxalic acid, malonic acid, succinic acid, tartaric acid, malic acid and fumaric acid; tricarboxylic acids having 3 to 6 carbon atoms such as citric acid and isocitric acid; aromatic carboxylic acids such as salicylic acid; and ascorbic acid.

In the organic acids, salts of the carboxylic acids and ascorbic acid are contained as well. The organic acids can be used singularly or in a combination of two or more thereof. A content of the organic acid in the polishing composition of an embodiment of the invention, without particular restriction, is preferably in the range of about 0.005 to 5% by weight based on a total amount of the polishing composition.

Examples of the complexing agent include ethylenediaminetetraacetic acid (EDTA), hydroxyethylethylenediaminetriacetic acid (HEDTA), diethylenetriaminepentaacetic acid (DTPA), nitrilotriacetic acid (NTA), triethylenetetraminehexaacetic acid (TTHA), hydroxyethyliminodiacetic acid (HIDA), dihydroxyethylglycine (DHEG), ethylene glycol-bis(β-aminoethylether)-N,N′-tetraacetic acid (EGTA) and 1,2-diaminocyclohexane-N,N, N′,N′-tetraacetic acid (CDTA). The complexing agents can be used singularly or in a combination of two or more thereof. A content of the complexing agent in the polishing composition of an embodiment of the invention, without particular restriction, is preferably in the range of about 0.005 to 5% by weight based on a total amount of the polishing composition.

As the corrosion inhibitors, for instance, benzotriazole, tolyltriazole, benzotriazole-4-carboxylic acid and alkyl ester thereof, naphtotriazole and a derivative thereof, imidazole, quinaldic acid and invar derivative can be cited. The corrosion inhibitors can be used singularly or in a combination of two or more thereof. A content of the corrosion inhibitor in the polishing composition of an embodiment of the invention, without particular restriction, is preferably in the range of about 0.005 to 0.5% by weight based on a total amount of the polishing composition.

Examples of surfactant include anionic surfactants such as polyacrylic acid salt, alkylbenzene sulfonate, alkane sulfonate and α-olefin sulfonate; and nonionic surfactants such as fatty acid monoethanol amide, fatty acid diethanol amide, fatty acid ethylene glycol ester, monofatty acid glycerin ester, fatty acid sorbitan ester, fatty acid sucrose ester, alkylpolyoxyethylene ether, polyvinyl pyrrolidone, polyvinyl alcohol, hydroxyethyl cellulose, carboxymethyl cellulose and polyethylene glycol.

The surfactants can be used singularly or in a combination of two or more thereof. A content of the surfactant in the polishing composition, without particular restriction, is preferably about 1% by weight or less, more preferably in the range of about 0.001 to 0.1% by weight based on a total amount of the polishing composition.

Furthermore, the polishing composition according to an embodiment of the invention, within a range that does not damage preferable characteristics thereof, may contain alcohols. When alcohols are added, the dissolution stability of, for instance, the polishing accelerator can be improved. As the alcohols, aliphatic saturated alcohols having 1 to 6 carbon atoms are preferable.

Specific examples thereof include linear or branched chain aliphatic saturated alcohol having 1 to 6 carbon atoms such as methanol, ethanol, propanol, isopropanol, butanol, isobutanol, tert-butanol, pentanol and hexanol. The alcohols may have a substituent such as a hydroxyl group in an alkyl portion. The alcohols can be used singularly or in a combination of two or more thereof. A content of the alcohols in the polishing composition of an embodiment of the invention, without particular restriction, is preferably in the range of about 0.01 to 5% by weight based on a total amount of the polishing composition.

The polishing composition according to an embodiment of the invention can be produced by use of a method that includes for instance (1) through (5) steps below.

(1) Step of Preparing Acidic Aqueous Solution

In the step, an acidic aqueous solution is prepared. The acidic aqueous solution can be prepared by adding acid to water. Known acids can be used and examples thereof include inorganic acids such as hydrochloric acid, nitric acid and sulfuric acid and organic acids such as phosphoric acid. Among these, the inorganic acid is preferable and hydrochloric acid is particularly preferable. The acids can be used singularly or, as needs arise, in a combination of two or more thereof.

The pH of the acidic aqueous solution is preferably in the range of 1.0 to 3.0, more preferably in the range of 1.0 to 2.7, particularly preferably 2.

(2) Step of Mixing Acidic Aqueous Solution and Fumed Silica

In the step, the acidic aqueous solution and the fumed silica are mixed to prepare an acidic fumed silica dispersion solution. At the mixing thereof, a high shearing force is preferably applied. A mixing time is not particularly restricted. However, 1 hr or more is preferable and 2 hr or more is more preferable.

A concentration of the fumed silica in the acidic fumed silica dispersion solution is, though not particularly restricted, preferably in the range of 40 to 60% by weight, more preferably in the range of 46 to 54% by weight to an entire dispersion solution.

(3) Step of Diluting Acidic Fumed Silica Dispersion Solution

In the step, water is added to the acidic fumed silica dispersion solution to dilute the concentration of the fumed silica in the dispersion solution preferably to 30 to 45% by weight, more preferably to 33 to 44% by weight.

At that time, the dispersion solution is preferably diluted not by one-time addition of water but by a plurality of times of additions of water to gradually dilute to a desired concentration. About two to four times of additions of water are particularly preferable.

For instance, to the acidic fumed silica dispersion solution, water of an amount that reduces the concentration of the fumed silica by 1% by weight is added, followed by mixing for about 10 to 40 min. Subsequently, water of an amount that reduces the concentration of the fumed silica to a desired concentration is added, followed by mixing for about 30 min to 4 hr. At the mixing, a shearing force is preferably applied.

A mixing time after water is added to the acidic fumed silica dispersion solution, without restricting to the above-mentioned ones, can be appropriately selected depending on a degree of dilution (addition of water). Normally, as the degree of dilution becomes larger, the mixing time is preferably made longer.

(4) Step of Preparing Alkali Aqueous Solution

In the step, an alkali aqueous solution is prepared. The alkali aqueous solution can be prepared by adding alkali to water. Known alkalis can be used and examples thereof include alkali metal hydroxides such as ammonium hydroxide, sodium hydroxide and potassium hydroxide; and alkaline earth metal hydroxides such as calcium hydroxide, barium hydroxide and magnesium hydroxide. Among these, alkali metal hydroxides, ammonium hydroxide or the like are preferable and ammonium hydroxide is more preferable. The alkalis may be used singularly or in a combination of two or more thereof as needs arise.

To the alkali aqueous solution, one or two or more general additives such as a polishing accelerator, an oxidant, an organic acid, a complexing agent, a corrosion inhibitor and a surfactant can be added.

The pH of the alkali aqueous solution is preferably in the range of 12 to 14.

(5) Step of Preparing Polishing Composition

In the step, a polishing composition of an embodiment of the invention is prepared.

The acidic fumed silica dispersion solution is added to the alkali aqueous solution and mixed, and thereby a polishing composition of an embodiment of the invention can be prepared.

At the mixing, the acidic fumed silica dispersion solution is necessarily added to the alkali aqueous solution. By contrast, when the alkali aqueous solution is added to the acidic fumed silica dispersion solution, the aqueous dispersibility of the fumed silica is deteriorated; accordingly, a desired polishing composition cannot be obtained.

Furthermore, at the mixing, since the alkali aqueous solution is strongly alkaline and the acidic fumed silica dispersion solution is strongly acidic, when the acidic fumed silica dispersion solution is gradually added over a long time to the alkali aqueous solution, the fumed silica tends to be agglomerated. Accordingly, depending on a concentration of the fumed silica in the acidic fumed silica dispersion solution, it is preferably added so as not to cause agglomeration. More preferably, it is well to carry out so that the acidic fumed silica dispersion solution may be added to the alkali aqueous solution within 5 hr.

A mixing ratio of the acidic fumed silica dispersion solution and the alkali aqueous solution is not particularly restricted. The acidic fumed silica dispersion solution and the alkali aqueous solution only need to be mixed so that the pH of the polishing composition becomes preferably in the range of 8 to 12 and a concentration of the fumed silica may be preferably in the range of 10 to 30% by weight.

Thus obtained polishing composition can be, as needs arise, subjected to a classification process. Known classification method can be applied and for instance, filtration can be cited. As a filter that is used in the filtration, a depth filter having filtration accuracy of about 1 to 5 μm can be cited.

Water that is used to prepare the polishing composition of an embodiment of the invention is not particularly restricted; however, in view of the applications, ultrapure water, pure water, ion-exchanged water and distilled water are preferably used.

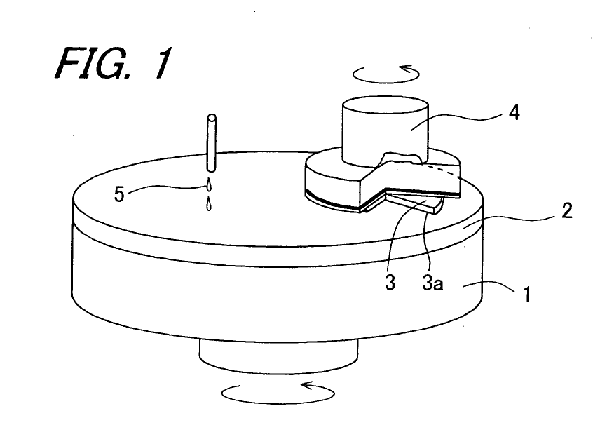

When a semiconductor device such as a wafer is polished with the polishing composition of an embodiment of the invention, except that, in place of an existing polishing composition, the polishing composition of an embodiment of the invention is used, the polishing can be carried out similarly as ever. For instance, as shown in FIG. 1, a wafer 3 is placed on a pad 2 stuck to a polishing bed 1 so that a surface being polished of the wafer 3 may come into contact with the pad 2, and, with a pressure head 4 pressed against the wafer 3 to apply a constant weight on the wafer 3 and with a polishing composition 5 supplying on a surface of the pad 2, the pad 2 and the pressure head 4 are rotated to polish the wafer 3.

The polishing composition of an embodiment of the invention can be used as a polishing composition generally in the CMP processing of a wafer. Specifically, the polishing composition can be preferably used to polish a wafer having a thin film formed thereon. The thin film formed on the wafer includes: a film of a metal such as W, Cu, Ti and Ta; a film of ceramics such as TiN, TaN and Si₃N₄; a film of oxide such as SiO₂ and p-TEOS; and a low dielectric film such as a HSQ film, a methylated HSQ film, a SiLK film and a porous film.

Furthermore, the polishing composition of an embodiment of the invention, without restricting to the CMP polishing of the semiconductor wafer, can be preferably used when, in the applications other than the above-mentioned applications, metals and ceramics are polished.

### EXAMPLES

In what follows, with reference to Examples, Comparative Examples and Test Examples, the invention will be specifically described.

### Example 1

[Preparation of Acidic Fumed Silica Dispersion Solution]

To ultrapure water, a 0.01N hydrochloric acid aqueous solution was added and the pH was adjusted to 2. To the hydrochloric acid aqueous solution, fumed silica (average primary particle diameter: 20 nm and specific surface area: 90 m²/g) was added followed by stirring for 2 hr 30 min, and thereby an acidic fumed silica dispersion solution of which fumed silica concentration is 50% by weight was prepared.

[Dilution of Acidic Fumed silica Dispersion Solution]

To the acidic fumed silica dispersion solution, ultrapure water was added followed by mixing for 30 min. Thereby, an acidic fumed silica dispersion solution of which fumed silica concentration is 49% by weight was obtained.

Furthermore, to the acidic fumed silica dispersion solution of which fumed silica concentration is 49% by weight, ultrapure water was added followed by mixing for 1 hr. Thereby, an acidic fumed silica dispersion solution of which fumed silica concentration is 40% by weight was obtained. The pH of the dispersion solution was 2.

The mixings all were carried out under application of a shearing force with a high-shearing dispersion unit (trade name: HIVIS DISPER, manufactured by Tokushu Kika Kogyo Co., Ltd.).

[Preparation of Alkali Aqueous Solution]

To ultrapure water, a 0.9% by weight ammonium hydroxide aqueous solution was added to prepare an alkali aqueous solution of pH 13.

[Preparation of Polishing Composition of the Invention]

To 26.3 kg of the alkali aqueous solution, 43.7 kg of the acidic fumed silica dispersion solution of which concentration of the fumed silica is 40% by weight was added under stirring, followed by further mixing for 0.1 hr after the completion of the addition, and thereby a polishing composition of an embodiment of the invention was prepared.

The obtained polishing composition was filtered with a filter having filtration accuracy of 1 μm (trade name: Profile 2, manufactured by Nippon Pall Co., Ltd.) to remove coarse agglomerated particles. The polishing composition had an average particle diameter of the fumed silica: 90 nm, a fumed silica concentration of 25% by weight and the pH of 10.5.

### Example 2

In a step of preparing an acidic fumed silica dispersion solution, except that a time of mixing a hydrochloric acid aqueous solution of pH 2 and the fumed silica is changed to 2 hr, similarly to Example 1, a polishing composition according to an embodiment of the invention (an average particle diameter of the fumed silica: 110 nm, a concentration of the fumed silica: 25% by weight and pH: 10.5) was prepared.

### Example 3

In a step of preparing an acidic fumed silica dispersion solution, except that a time of mixing a hydrochloric acid aqueous solution of pH 2 and the fumed silica is changed to 4 hr, similarly to Example 1, a polishing composition according to an embodiment of the invention (an average particle diameter of the fumed silica: 87 nm, a concentration of the fumed silica: 25% by weight and pH: 10.5) was prepared.

### Comparative Example 1

To ultrapure water, the fumed silica was added so that a concentration may be 30% by weight, followed by dispersing for 30 min, further followed by dispersing under application of a shearing force with a high shear disperser (HIVIS Disper), and thereby a fumed silica dispersion solution of which fumed silica concentration is 30% by weight was prepared.

The fumed silica dispersion solution and a 0.9% by weight ammonium hydroxide aqueous solution were mixed, and thereby a polishing composition according to Comparative Example 1 (an average particle diameter of the fumed silica: 150 nm, a concentration of the fumed silica: 13% by weight and pH: 10.7) was prepared.

### Comparative Example 2

In accordance with Example 1 of JP-B2 2935125, a polishing composition was prepared, filtered with a filter having the filtration accuracy of 5 μm, and thereby a polishing composition according to Comparative Example 2 (an average particle diameter of the fumed silica: 120 nm, a concentration of the fumed silica: 25% by weight and pH: 11) was prepared. The polishing composition caused clogging when filtered with a filter having the filtration accuracy of 1 μm and could not be filtered sufficiently.

### Comparative Example 3

In accordance with Example 1 of JP-B2 2949633, a polishing composition was prepared, filtered with a filter having the filtration accuracy of 10 μm, and thereby a polishing composition according to Comparative Example 3 (an average particle diameter of the fumed silica: 120 nm, a concentration of the fumed silica: 25% by weight and pH: 11) was prepared. The polishing composition caused clogging when filtered with a filter having the filtration accuracy of 1 μm and could not be filtered sufficiently.

### Comparative Example 4

In accordance with Example 1 of JP-A 2001-26771, a polishing composition was prepared, filtered with a filter having the filtration accuracy of 3 μm, and thereby a polishing composition according to Comparative Example 4 (an average particle diameter of the fumed silica: 131 nm, a concentration of the fumed silica: 12.5% by weight and pH: 10.5) was prepared. The polishing composition caused clogging when filtered with a filter having the filtration accuracy of 1 μm and could not be filtered sufficiently.

### Test Example 1

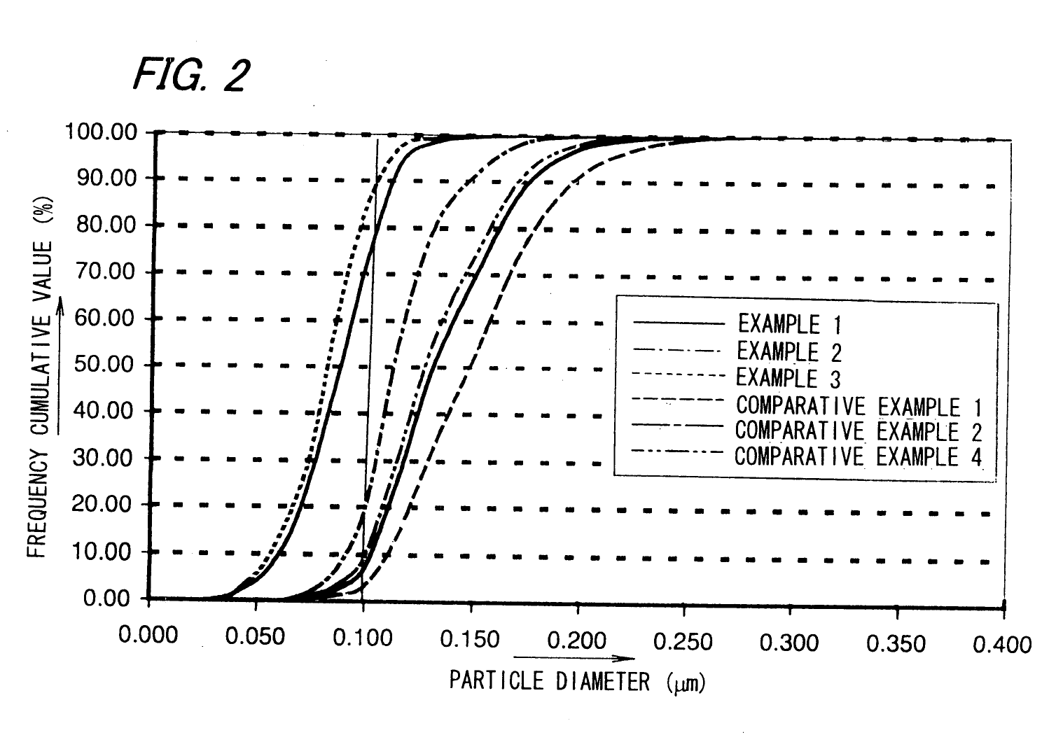

A particle size distribution of the fumed silica was measured of each of the Examples 1 through 3 and Comparative Examples 1 through 4 with a laser diffraction/scattering particle size distribution analyzer (trade name: LA910). Results are shown in FIGS. 2 through 4.

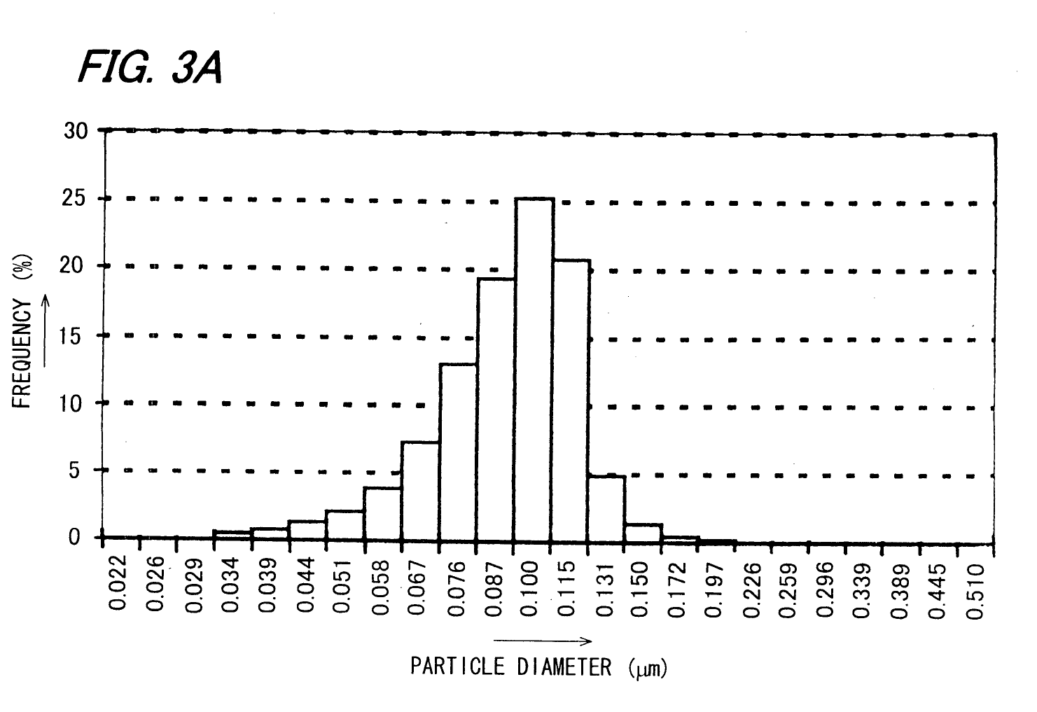

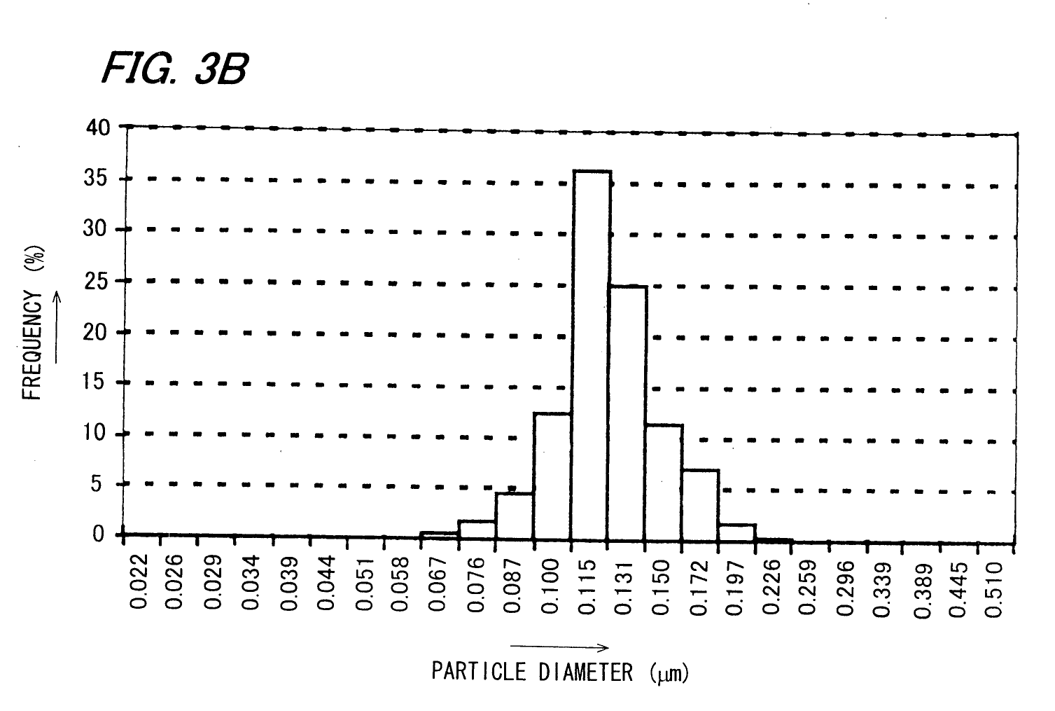

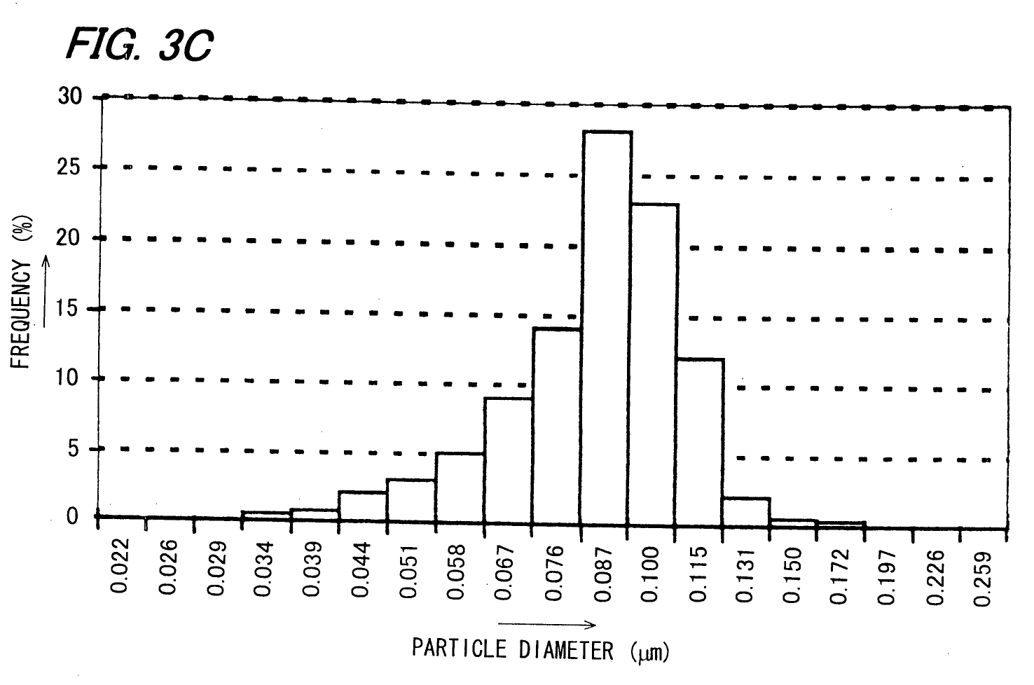

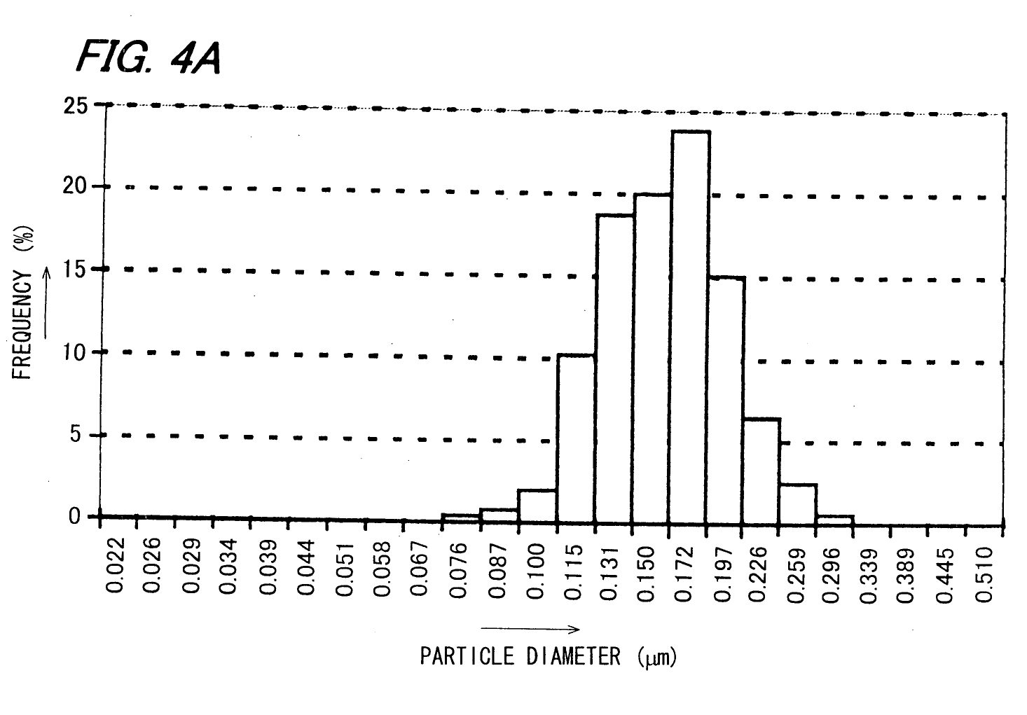

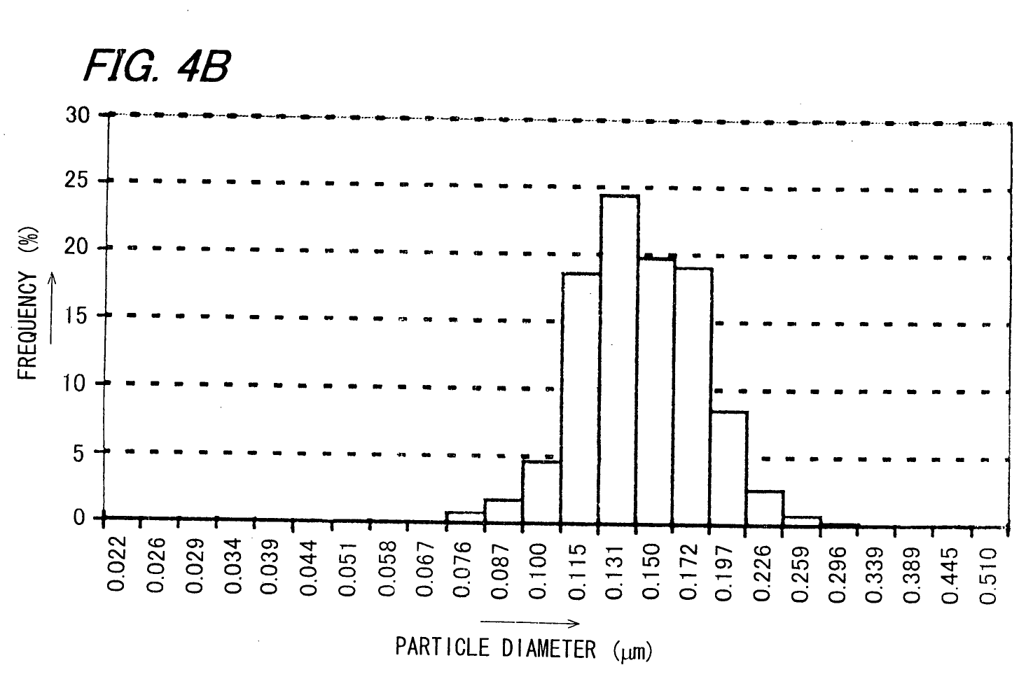

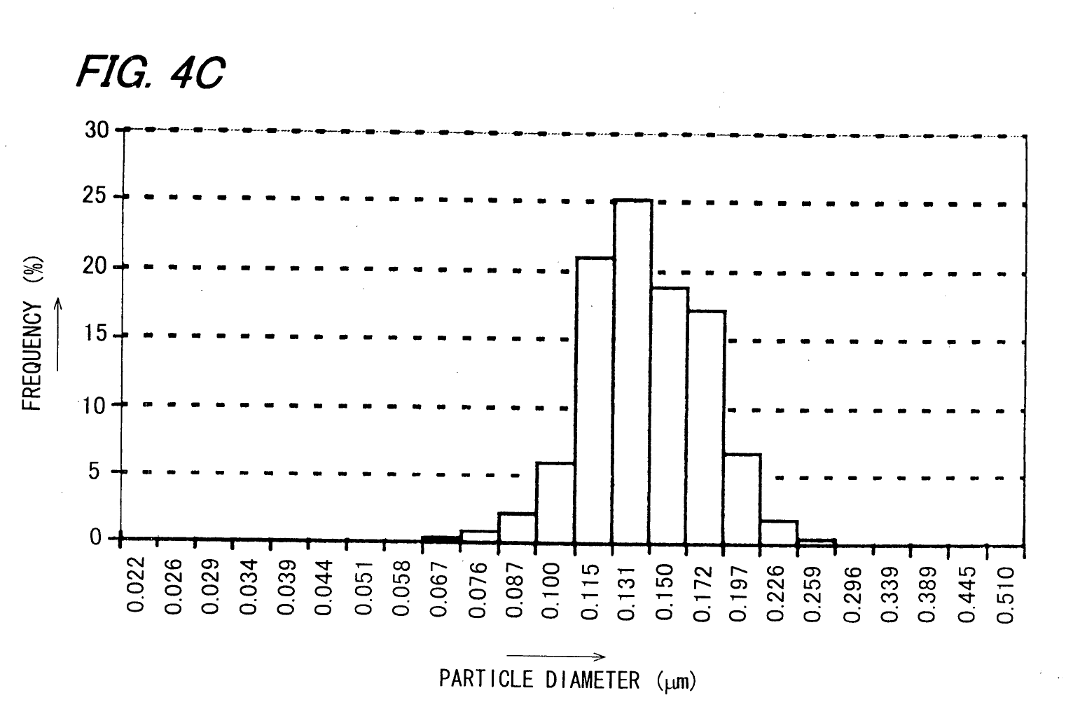

FIG. 2 is a graph where a horizontal axis shows a particle diameter (μm) and a vertical axis shows a frequency cumulative value (%) and that shows a volume ratio in a total amount of fumed silica particles of particles having the respective particle diameters (μm) or less in the polishing composition as a frequency cumulative value (%). Each of FIGS. 3 and 4 is a graph where a horizontal axis shows a particle diameter (μm) and a vertical axis shows a frequency (%) and that shows a volume ratio in a total of fumed silica particles of particles having the respective particle diameters in the polishing composition as a frequency (%).

In FIG. 3, FIG. 3A, FIG. 3B and FIG. 3C, respectively show Example 1, Example 2 and Example 3. Furthermore, in FIG. 4, FIG. 4A, FIG. 4B and FIG. 4C, respectively show Comparative Example 1, Comparative Example 2 and Comparative Example 4.

A volume ratio of particles having particle diameters of 100 nm or less was 78% for Example 1, 20% for Example 2, 89% for Example 3, 3% for Comparative Example 1, 6% for Comparative Example 2 and 9% for Comparative Example 4. Comparative Example 3 showed a value substantially same as Comparative Example 2.

The maximum frequency that shows the largest volume ratio was 0.100 μm for Example 1, 115 μm for Example 2, 0.087 μm for Example 3, 0.172 μm for Comparative Example 1, 0.131 μm for Comparative Example 2 and 0.131 μm for Comparative Example 4. Comparative Example 3 showed a value substantially same as Comparative Example 2.

### Test Example 2

With each of the polishing compositions according to Examples 1 through 3 and Comparative Examples 1 through 4, under the conditions below, a silicon wafer was polished.

[Polishing Conditions]

Silicon wafer: 8−-PTEOS, manufactured by Advantec Co.,

Polishing device: trade name SH-24, manufactured by SpeedFam Inc.,

Polishing pad: trade name IC1400A2, 050 K-Grv. 24″P9H

Rotation speed of polishing bed: 60 rpm

Rotation speed of pressure head: 41 rpm

Surface pressure of polishing load: about 4.83×10⁴ Pa (7 psi)

Flow rate of semiconductor polishing composition: 100 ml/min

Polishing time: 60 sec

A surface of each of polished semiconductor wafers was observed with an wafer surface inspection device and the number of polishing flaws having a diameter of 0.2 μm or more per one semiconductor wafer was investigated. The polishing test was carried out three times of the respective compositions. Results are shown in Table 1.

TABLE 1

| | Polishing Flaws (pieces) | | |
|---|---|---|---|
| | First Time | Second Time | Third Time |
| Example 1 | 34 | 44 | 31 |
| Example 2 | 63 | 28 | 29 |
| Example 3 | 42 | 33 | 36 |
| Comparative | 324 | 242 | 217 |
| Example 1 | | | |
| Comparative | 261 | 399 | 305 |
| Example 2 | | | |
| Comparative | 249 | 232 | 263 |
| Example 4 | | | |

When a semiconductor polishing composition according to Comparative Example 3 is used, the polishing flaws were generated at the number substantially same as that of Comparative Example 2.

From table 1, it is obvious that while in the semiconductor polishing compositions of Examples 1 and 2 the number of the polishing flaws having a diameter of 0.2 μm or more does not reach 100, in the compositions of Comparative Examples 1 through 3 the number of the polishing flaws having a diameter of 0.2 μm or more largely exceeds 100. At present, in order to secure the reliability of the electrical connection of the semiconductor wafer, the number of the polishing flaws having a diameter of 0.2 μm or more is demanded to be less than 100. Accordingly, the compositions according to Examples 1 through 3 are obvious to be excellent semiconductor polishing compositions that can satisfy the requirement.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to at least one embodiment of the invention, a semiconductor polishing composition that is an aqueous dispersion solution of fumed silica and contains the fumed silica having a particle diameter of 100 nm or less by 15% by volume or more, preferably in the range of 15 to 90% by volume, based on a total amount of the fumed silica can be provided.

The polishing composition of at least one embodiment of the invention is very slightly agglomerated owing to external load and/or long-term storage. Accordingly, when the polishing composition is used to polish a semiconductor device, the polishing flaws are hardly generated on the semiconductor device; accordingly, after the polishing of the semiconductor device, the reliability in the electrical connection can be further improved. In addition, the semiconductor device can be efficiently polished (flattened) at a high polishing speed. Accordingly, the yield of the polished semiconductor device can be improved to improve the production efficiency.

Furthermore, according to an embodiment of the invention, when a semiconductor polishing composition where a content of the fumed silica having a particle diameter of 100 nm or less is 15% by volume or more, preferably in the range of 15 to 90% by volume, and, in a particle size distribution by volume of the fumed silica, a particle diameter of the maximum frequency is 115 nm or less, preferably in the range of 80 to 115 nm, is used, the above-mentioned advantages of at least one embodiment of the invention can be made more conspicuous.

Furthermore, according to an embodiment of the invention, in a polishing composition of the invention, a content of fumed silica based on a total amount of the polishing composition is preferably in the range of 10 to 30% by weight, more preferably in the range of 10 to 28% by weight. When a content of the fumed silica is within the range, the aqueous dispersibility thereof is particularly excellent.

Furthermore, according to an embodiment of the invention, the polishing composition according to an embodiment of the invention is preferably produced by adding an acidic fumed silica dispersion solution to an aqueous alkali solution, followed by blending.

At this time, the pH of the aqueous alkali solution is preferably set in the range of 12 to 14. When the pH is thus controlled, the polishing composition according to an embodiment of the invention can be readily produced.

1. A semiconductor polishing composition comprising:
fumed silica, the semiconductor polishing composition being an aqueous dispersion solution of fumed silica,
wherein a content of the fumed silica having a particle diameter of 100 nm or less is 15% by volume or more based on a total amount of the fumed silica.

2. The semiconductor polishing composition of claim 1, wherein a content of fumed silica having a particle diameter of 100 nm or less is in a range of 15 to 90% by volume based on a total amount of the fumed silica.

3. The semiconductor polishing composition of claim 1, wherein, in a particle size distribution by volume of the fumed silica, the semiconductor polishing composition has a particle size of the maximum frequency in a range of 115 nm or less.

4. The semiconductor polishing composition of claim 1, wherein, in a particle size distribution by volume of the fumed silica, the semiconductor polishing composition has a particle size of the maximum frequency in a range of 80 to 115 nm.

5. The semiconductor polishing composition of claim 1, wherein a content of the fumed silica is in a range of 10 to 30% by weight based on a total amount of the composition.

6. The semiconductor polishing composition of claim 1, wherein the semiconductor polishing composition is prepared by adding an acidic fumed silica dispersion solution to an alkali aqueous solution.

7. The semiconductor polishing composition of claim 6, wherein a pH of the alkali aqueous solution is in a range of 12 to 14.

8. The semiconductor polishing composition of claim 2, wherein, in a particle size distribution by volume of the fumed silica, the semiconductor polishing composition has a particle size of the maximum frequency in a range of 115 nm or less.

9. The semiconductor polishing composition of claim 2, wherein, in a particle size distribution by volume of the fumed silica, the semiconductor polishing composition has a particle size of the maximum frequency in a range of 80 to 115 nm.

10. The semiconductor polishing composition of claim 3, wherein, in a particle size distribution by volume of the fumed silica, the semiconductor polishing composition has a particle size of the maximum frequency in a range of 80 to 115 nm.

11. The semiconductor polishing composition of claim 8, wherein, in a particle size distribution by volume of the fumed silica, the semiconductor polishing composition has a particle size of the maximum frequency in a range of 80 to 115 nm.

12. The semiconductor polishing composition of claim 2, wherein a content of the fumed silica is in a range of 10 to 30% by weight based on a total amount of the composition.

13. The semiconductor polishing composition of claim 3, wherein a content of the fumed silica is in a range of 10 to 30% by weight based on a total amount of the composition.

14. The semiconductor polishing composition of claim 4, wherein a content of the fumed silica is in a range of 10 to 30% by weight based on a total amount of the composition.

15. The semiconductor polishing composition of claim 2, wherein the semiconductor polishing composition is prepared by adding an acidic fumed silica dispersion solution to an alkali aqueous solution.

16. The semiconductor polishing composition of claim 3, wherein the semiconductor polishing composition is prepared by adding an acidic fumed silica dispersion solution to an alkali aqueous solution.

17. The semiconductor polishing composition of claim 4, wherein the semiconductor polishing composition is prepared by adding an acidic fumed silica dispersion solution a to an alkali aqueous solution.

18. The semiconductor polishing composition of claim 5, wherein the semiconductor polishing composition is prepared by adding an acidic fumed silica dispersion solution to an alkali aqueous solution.
